(19) United States
(12) Patent Application Publication
(10) Pub. No.: US 2002/0020280 A1
(43) Pub. Date: Feb. 21, 2002

(54) Tuning device

(76) Inventor: Masaji Kondo, Chiba-shi (JP)

Correspondence Address: ADAMS & WILKS, 31st Floor, 50 Broadway, New York, NY, 10004, US

(21) Appl. No.: 09/923,112

(22) Filed: Aug. 6, 2001

(30) Foreign Application Priority Data
Aug. 18, 2000 (JP) 2000-248749

(51) Int. Cl. G10H 5/00

(52) U.S. Cl. 84/647

(57) ABSTRACT

There is provided a thin tuning device equipped with jacks for inputting or outputting a signal, the tuning device employs a main body case, a back case, and a printed board as parts of the components of the jacks so that the thickness of the jacks and of the tuning device can be reduced.

### BACKGROUND OF THE INVENTION

1. Field of the Invention

The present invention relates to an input jack and an output jack of a tuning device for tuning a musical instrument.

2. Description of the Related Art

In a conventional tuning device, as shown in FIG. 5, a jack 9 available on the market is mounted on a printed board 3 by soldering 7 and the printed board 3 on which the jack 9 is mounted is accommodated in a main body case 1 and a back case 2.

However, in the above described conventional structure, the thickness of the tuning device main body is determined depending on the thickness of the jack 9, the thickness of the top part of the main body case 1, the thickness of the printed board 3 and the thickness of the bottom part of the back case 2, so that it has been difficult to reduce the thickness of the tuning device.

### SUMMARY OF THE INVENTION

Thus, in order to solve the above described problem, it is an object of the present invention to reduce the thickness of jacks and of a tuning device by using a main body case and a back case of the tuning device and a printed board as parts of the components of the jacks.

To achieve the above described object, according to the present invention, there is provided a tuning device comprising a main body case, a back case, a printed board and jacks, wherein the main body case, the back case and the printed board of the tuning device are employed as parts of the components of the jacks so as to reduce the thickness of the jacks and of the tuning device.

### BRIEF DESCRIPTION OF THE DRAWINGS

Other characteristics will appear on reading the following description with reference to the attached drawings in which:

FIG. 1 is an exploded perspective view from a main body case side of a tuning device showing an embodiment of the present invention;

FIG. 2 is an exploded perspective view from a back case side of the tuning device showing the embodiment of the present invention;

FIG. 3 is a circuit diagram of a jack part in the tuning device;

FIG. 4 is an exploded perspective view when the contacts of the jacks of the tuning device which shows the embodiment of the present invention are electrically communicated to a printed board by pressure welding; and

FIG. 5 is a sectional view of a jack part showing the structure of a conventional tuning device.

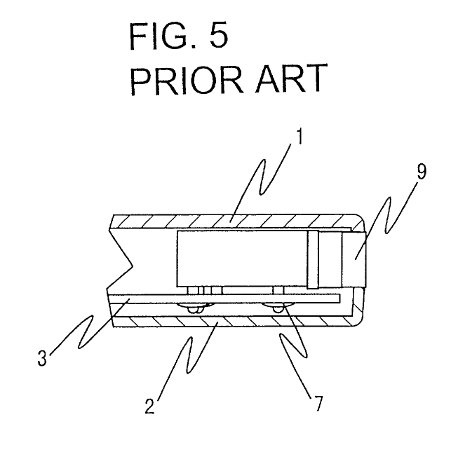

### DETAILED DESCRIPTION OF THE PREFERRED EMBODIMENT

An embodiment of a tuning device according to the present invention will now be described by referring to the accompanying drawings.

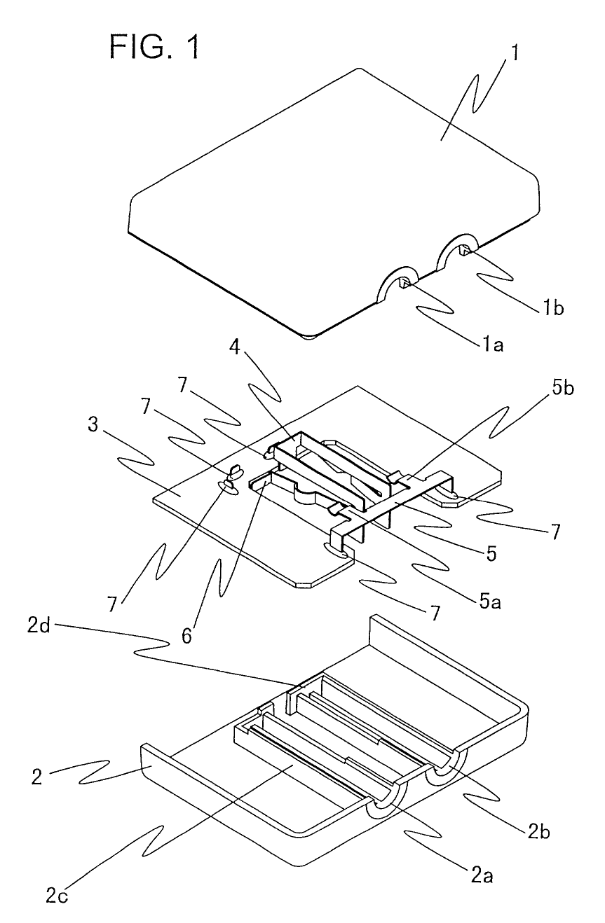

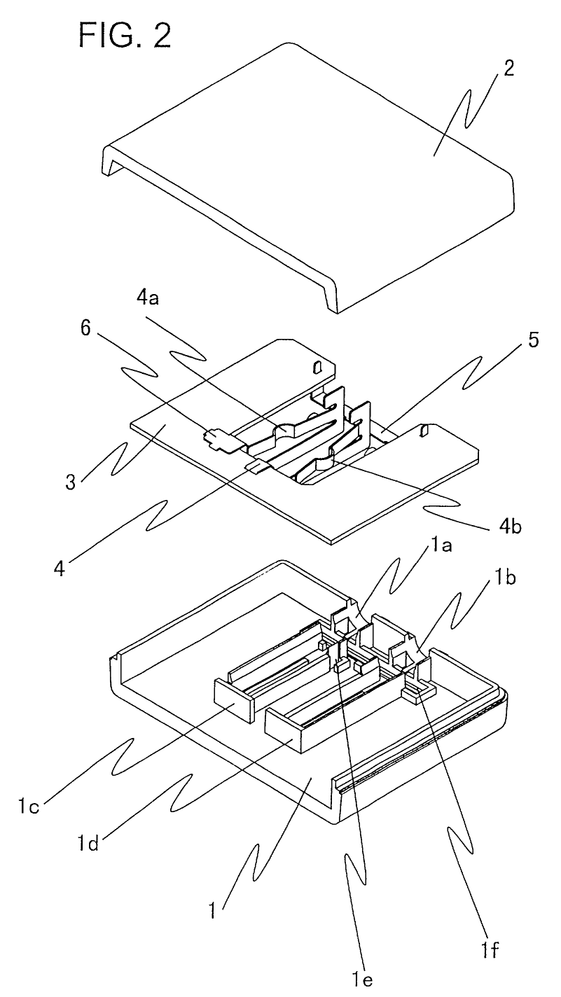

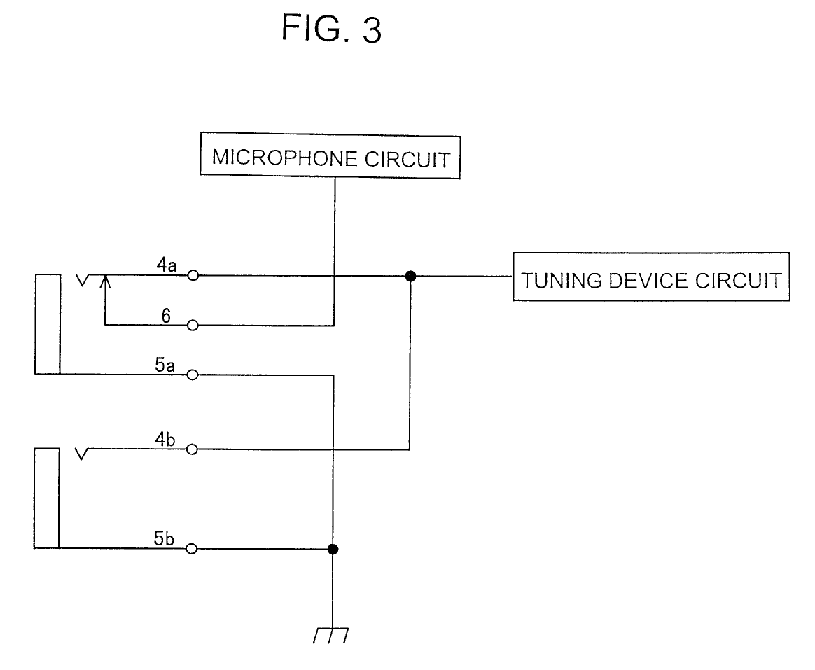

FIG. 1 is an exploded perspective view of a jack part from a main body case side which shows the structure of one embodiment of the tuning device according to the present invention. FIG. 2 is similarly an exploded perspective view of the jack part from a back case side which shows the structure of the tuning device according to the present invention. FIGS. 1 and 2 simply show only the jack part. Further, FIG. 3 is a circuit diagram of the jack part of the tuning device.

Hereinbelow, description will be made of the structure of the tuning device with reference to FIGS. 1, 2 and 3.

A printed board 3 to which a chip contact 4 as a contact of a jack, a sleeve contact 5 and a break contact 6 are fixed by soldering 7 is mounted on a main body case 1. The printed board 3 has a cut-out part at its one end, and a plug is inserted into the cut-out part to come into contact with the respective contacts. At this time, the chip contact 4 on which a force is exerted by inserting the plug into or pulling out the plug from the cut-out part is supported by a chip contact support groove 1e formed in a main body case 1 and the sleeve contact 5 is similarly supported by a sleeve contact support groove 1f formed in the main body case 1.

The main body case 1 is fitted to a back case 2 so that an input plug insert part 1a and an output plug insert part 1b formed in the main body case 1 and an input plug insert part 2a and an output plug insert part 2b formed in the back case 2 form an input plug inserting part and an output plug inserting part. Further, a rib 1c formed in the main body case 1 and a rib 2c formed in the back case 2 form a guide for preventing a struggle of an input plug at the time of inserting the input plug. Further, a rib 1d formed in the main body case 1 and a rib 2d formed in the back case 2 form a guide for preventing a struggle of an output plug at the time of inserting the output plug.

In FIG. 3, a chip contact 4a of an input jack is electrically connected to a chip contact 4b of an output jack. Therefore, the chip contact 4 in which the chip contact 4a of the input jack is formed integrally with the chip contact 4b of the output jack is used so that the number of parts can be decreased. Further, in FIG. 3, a sleeve contact 5a of the input jack is electrically connected to a sleeve contact 5b of the output jack. Therefore, the sleeve in which the sleeve contact 5a of the input jack is formed integrally with the sleeve contact 5b of the output jack is employed so that the number of parts can be decreased.

As described above, the jack of the tuning device is composed of the main body case 1, the back case 2 and the printed board 3 on which the chip contact 4, the sleeve contact 5 and the break contact 6 are mounted, so that the respective contacts forming the jack are divided into upper and lower sides with respect to the printed board 3. Further, since the plug insert parts and the plug struggle preventing parts are formed by the main body case and the back case, the thickness of the jack part can be reduced.

Further, in the structure having the chip contact 4 and the sleeve contact 5 formed integrally in the input jack and the output jack, respectively, the number of parts can be decreased and the number of assembling steps can be simplified.

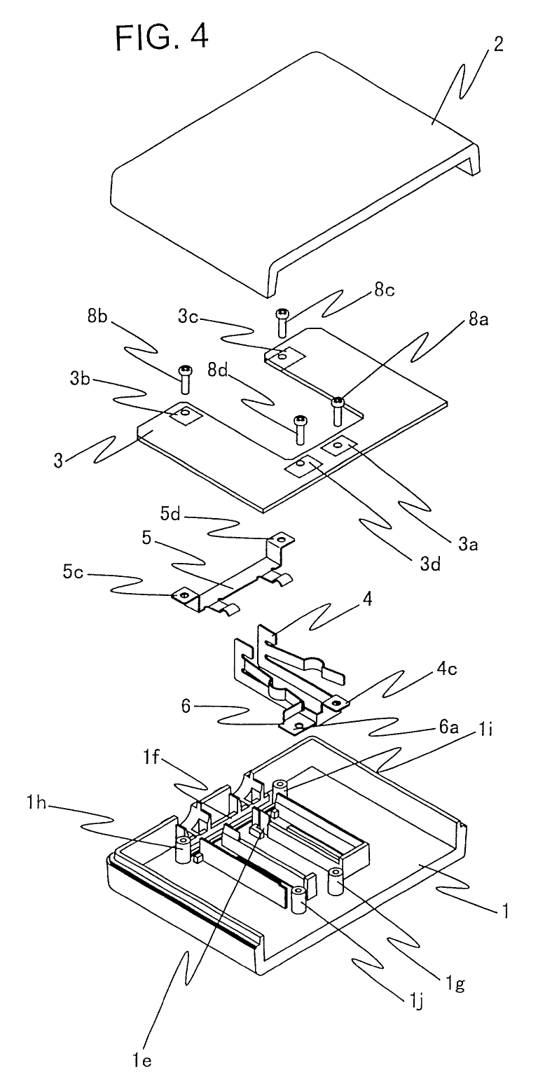

FIG. 4 is an exploded perspective view of the embodiment when the chip contact 4, the sleeve contact 5, and the break contact 6 of the tuning device according to the present invention are electrically communicated to the printed board 3 by pressure welding. Its structure will now be described with reference to FIG. 4.

The chip contact 4 is mounted onto a chip contact support groove 1e and a chip contact attaching boss 1g formed in the main body case 1. Further, the sleeve contact 5 is mounted on to a sleeve contact support groove 1f and sleeve contact attaching bosses 1h and 1i formed in the main body case 1. The break contact 6 is mounted onto a break contact attaching boss 1j formed in the main body case 1. At this time, the chip contact 4a of the input jack of the chip contact 4 comes into contact with the break contact 6. The printed board 3 is mounted thereon and the chip contact 4 is fixed to the main case 1 and the printed board 3 by a screw 8a and the chip contact fixing boss 1g. Thus, a chip contact electrode 3a provided on the side surface of the main body case of the printed board 3 is press-welded to a screw fixing part 4c of the chip contact 4 to achieve the electrical communication of the chip contact 4. Further, the sleeve contact 5 is fixed to the main body case 1 and the printed board 3 by a screw 8b and the sleeve contact attaching boss 1h, and a screw 8c and the sleeve contact attaching boss 1i. Thus, sleeve contact electrodes 3b and 3c provided on the side surface of the main body case of the printed board 3 are press-welded to the screw fixing parts 5c and 5d of the sleeve contact 5 to achieve the electrical communication of the sleeve contact 5. Still further, the break contact 6 is fixed to the main body case 1 and the printed board 3 by a screw 8d and the break contact attaching boss 1j. Thus, a break contact electrode 3d provided on the side surface of the main body case of the printed board 3 is press-welded to the screw fixing part 6a of the break contact 6 to realize the electrical communication of the break contact 6. Further, the back case 2 is fitted to the main body case 1 so that the input jack and the output jack of the tuning device are formed.

In the jacks for the tuning device formed as described above, the thickness of the jack parts can be reduced. Furthermore, since the respective contacts are press-welded to the printed board 3 to realize an electrical communication, the accuracy in attaching the respective contacts to the printed board 3 upon mounting the contacts on the main body case 1 is not need to be paid attention to. Accordingly, the assembly steps can be further simplified.

As mentioned above, according to the present invention, since the main body case, the back case, and the printed board of the tuning device are employed as parts of the components of the jacks so that the respective contacts of the jacks are formed in the divided forms in the upper and lower sides with respect to the printed board, and the plug insert parts and the plug struggle preventing parts are formed by the main body case and the back case, the thickness of the jacks and of the tuning device can be reduced.

What is claimed is:

1. A tuning device having an input jack for inputting musical sound of an electronic musical instrument or the like, and an output jack for outputting the musical sound inputted from the input jack to an external amplifier, the tuning device comprising:
a main body case;
a back case fitted to the main body case; and
a printed board on which an electronic circuit is mounted and which is accommodated in the main body case and the back case, wherein the input jack and the output jack use the main body case, the back case and the printed board as parts of the components of the input jack and the output jack.

2. A tuning device according to claim 1, wherein chip contacts each forming the input jack and the output jack are integrally formed.

3. A tuning device according to claim 1, wherein sleeve contacts each forming the input jack and the output jack are integrally formed.

4. A tuning device according to claim 1, wherein respective contacts forming the respective jacks are press-welded to the printed board to electrically communicate the contacts to the printed board.

5. A tuning device having jacks for inputting or outputting signals, the tuning device comprising:
a case having an insert port for a plug;
a printed board accommodated in the case and having a cut-out part at one end; and
contacts provided on the printed board, wherein the plug inserted into the cut-out part of the printed board from the insert port comes into contact with the contacts in the cut-out part.
